(19) United States
(12) Patent Application Publication
(10) Pub. No.: US 2017/0121968 A1
(43) Pub. Date: May 4, 2017

(54) PREFABRICATED WALL SYSTEM

(71) Applicant: Armando Sada, San Antonio, TX (US)

(72) Inventor: Armando Sada, San Antonio, TX (US)

(21) Appl. No.: 15/290,793

(22) Filed: Oct. 11, 2016

Related U.S. Application Data
(60) Provisional application No. 62/238,875, filed on Oct. 8, 2015.

(51) Int. Cl. E04B 2/56; E04C 2/38; E06B 1/52; E04F 13/04; E06B 1/36; E04C 2/52; E04B 2/74

(52) U.S. Cl. CPC E04B 2/562; E04C 2/52; E04C 2/38; E04B 2/7457; E04F 13/04; E06B 1/36; E06B 1/52

(57) ABSTRACT

The disclosure provides a prefabricated wall system.

### CROSS-REFERENCE TO RELATED APPLICATIONS

The present applications claims priority to the earlier filed provisional application having Ser. No. 62/238,875, and hereby incorporates subject matter of the provisional application in its entirety.

### FIELD OF THE INVENTION

The present disclosure relates to a system, more specifically a prefabricated wall system.

### BACKGROUND OF THE INVENTION

The disclosed subject matter provides a system. The system may comprise a prefabricated wall. The system may provide wall components engrained within a prefabricated wall.

### BRIEF SUMMARY OF THE INVENTION

The disclosed subject matter provides a system. The system may comprise a frame layer and a drywall layer. The frame layer may comprise a first and second corner post each comprising a top end and a bottom end. A bottom plate may be affixed to the bottom end of the first corner post and the bottom end of the second corner post. A first top plate may be affixed to the first-corner-post top end and the second-corner-post top end. The disclosure may further provide a plurality of studs. The studs may run the height of the wall in between the first top plate and the bottom plate and may provide reinforcement to the wall. In embodiments, a plurality of noggins may run a length between two studs.

The system may further comprise a drywall layer. The drywall layer may comprise a gypsum plaster layer splayed between a first thick paper layer and a second thick paper layer. The drywall layer may further comprise a plurality of orifices. In embodiments, the orifices may comprise components associated with electricity, air, or water.

The prefabricated wall system may further comprise a plastic layer affixed between the frame layer and the drywall layer. The system may further comprise a plastic coating layer adjacent the periphery of the frame layer and the drywall layer.

In embodiments, insulation splayed within the frame layer. In embodiments, the prefabricated wall system may comprise a plurality of pipes splayed within the frame layer and the drywall layer.

### BRIEF DESCRIPTION OF THE DRAWINGS

The novel features believed characteristic of the disclosed subject matter will be set forth in any claims that are filed. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 displays an interior view of a prefabricated wall system in accordance with embodiments.

FIG. 2 displays an exterior view of a prefabricated wall system in accordance with embodiments.

FIG. 3 depicts a side layer view of a prefabricated wall system in accordance with embodiments.

FIG. 4 depicts a perspective view of prefabricated wall systems fit together at an angle.

FIG. 5 depicts an interior view of a prefabricated wall system including loop straps in accordance with embodiments.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

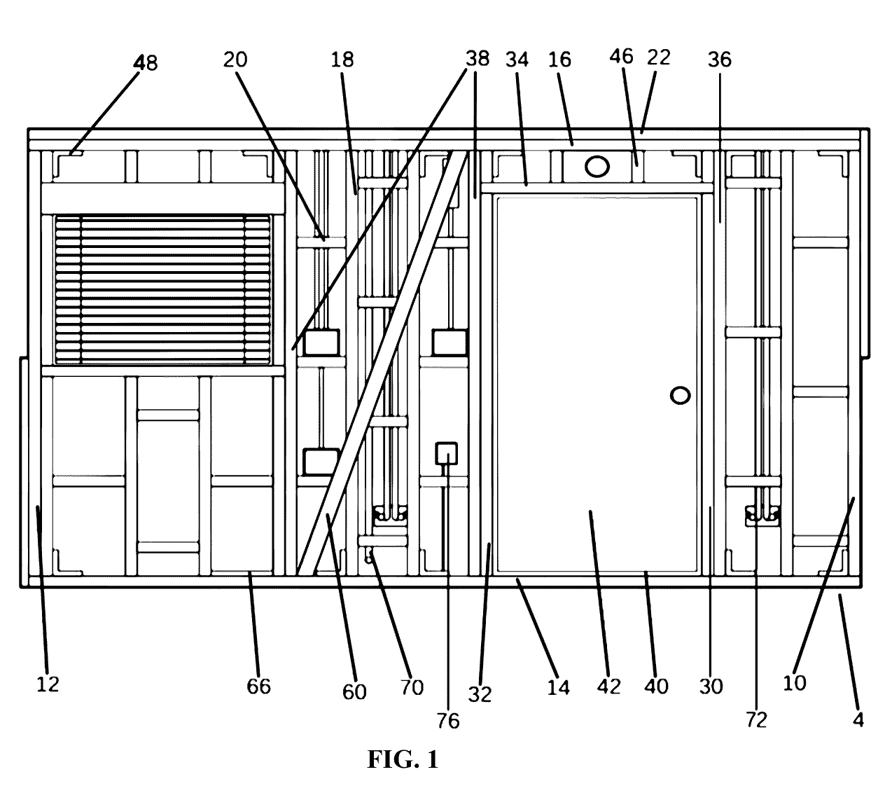

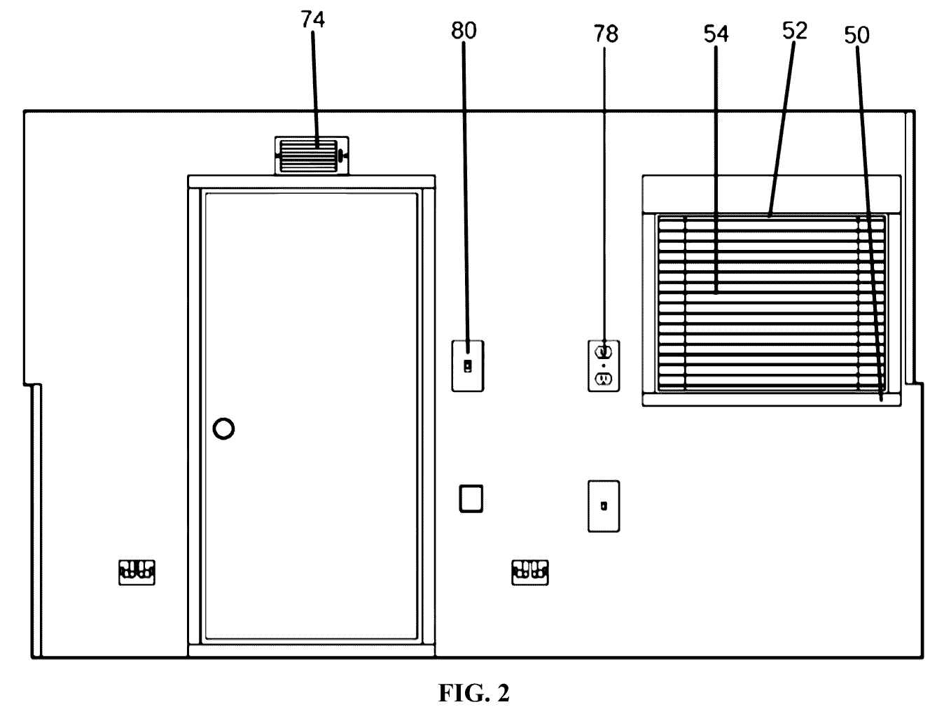

FIG. 1 displays an interior view of a prefabricated wall system 2 in accordance with embodiments. The system may comprise a frame layer 4 and a drywall layer 6 (FIG. 2). FIG. 1 may further show the prefabricated wall system 2 set up on a foundation of a house. The prefabricated wall system 2 may sit on top of and be affixed to a plurality of floor joists (ends shown). The floor joists may sit on top of and be affixed to a sill plate.

In embodiments, the frame layer may be comprised of any material, including but not limited to, wood, aluminum, metal, plastic, and recycled plastic.

In embodiments, the frame layer 4 may comprise a first and second corner post 12 each comprising a top end and a bottom end. A bottom plate 14 comprising a first end and a second end may be affixed to the bottom end of the first corner post 10 and the bottom end of the second corner post 12. A first top plate 16 may be affixed to the first-corner-post top end 10 and the second-corner-post top end 12. The disclosure may further provide a plurality of studs 18. The studs 18 may run the height of the wall in between the first top plate 16 and the bottom plate 14 and may provide reinforcement to the wall. In embodiments, a plurality of noggins 20 may run a length between two studs 18.

In embodiments, the first end of the bottom plate 14 may be affixed to the bottom end of the first corner post 10. In embodiments, the second end of the bottom plate 14 may be affixed to the bottom end of the second corner post 12.

In embodiments, studs may be comprised of any material, including but not limited to, wood, aluminum, metal, plastic, and recycled plastic.

In embodiments, the system may further comprise a door system. The door system may comprise first and second jack studs 30,32 each comprising top ends, bottom ends, interior surfaces, and exterior surfaces. In embodiments, the bottom ends of the first and second jack studs 30,32 may be affixed to the bottom plate 14.

The door system may further comprise a header 34 including a top edge, a bottom edge, a first side edge, and a second side edge. In embodiments, a first portion of the bottom edge of the header 34 may be affixed to the first-jack-stud top end 30. In embodiments, a second portion of the bottom edge of the header 34 may be affixed to the second-jack-stud top end 32.

The door system may further comprise a first king stud 36 comprising a top end, a bottom end, an interior surface, and an exterior surface. In embodiments, the interior surface of the first king stud 36 may be affixed to the exterior surface of the first jack stud 30 and the first side edge of the header 34. In embodiments, the first-king-stud top end 36 may be affixed to the first top plate 16. In embodiments, the bottom end of the first king stud 36 may be affixed to the bottom plate 14.

The door system may further comprise a second king stud 38 comprising a top end, a bottom end, an interior surface, and an exterior surface. In embodiments, the interior surface of the second king stud 38 may be affixed to the exterior surface of the second jack stud 32 and the second side edge of the header 34. In embodiments, the second-king-stud top end of 38 may be affixed to the first top plate 16. In embodiments, the second-jack-stud bottom end 32 may be affixed to the bottom plate 14;

The door system may further comprise a door frame 40 comprising an interior perimeter and an exterior perimeter. In embodiments, the exterior perimeter of the door frame 40 may be affixed to the bottom edge of the header 34, the interior surface of the first jack stud 30, and the interior surface of the second jack stud 32.

The door system may further comprise a door 42 comprising an exterior perimeter. In embodiments, a portion of the exterior perimeter may be affixed to the interior perimeter of the door frame 40.

In embodiments, the prefabricated wall system 2 with a door system may further comprise at least one cripple 46 each comprising a top end and a bottom end. The top end of the at least one cripple 46 may be affixed to the first top plate 16. The bottom end of the at least one cripple 46 may be affixed to the top end of the header 34.

In embodiments, the prefabricated wall system 2 with a door system may further comprise a structural connector 48 affixed adjacent a contact point of at least two of the first corner post 10, the second corner post 12, the first top plate 16, the bottom plate 14, the plurality of studs 18, the plurality of noggins 20, the first jack stud 30, the second jack stud 32, the header 34, the first king stud 36, the second king stud 38, and the at least one cripple 46. In embodiments, the structural connector 48 may be affixed via means such as, but not limited to one or more of adhesives, nails, screws, and rivets.

In embodiments, the system may further comprise a window system. The window system may comprise first and second jack studs 30,32 each comprising top ends, bottom ends, interior surfaces, and exterior surfaces. In embodiments, the bottom ends of the first and second jack studs 30,32 may be affixed to the bottom plate 14.

The window system may further comprise a header 34 comprising a top edge, a bottom edge, a first side edge, and a second side edge. In embodiments, a first portion of the bottom edge of the header 34 may be affixed to the first-jack-stud top end 30. In embodiments, a second portion of the bottom edge of the header 34 may be affixed to the second-jack-stud top end 32.

The window system may further comprise a first king stud 36 comprising a top end, a bottom end, an interior surface, and an exterior surface. In embodiments, the interior surface of the first king stud 36 may be affixed to the exterior surface of the first jack stud 30 and the first side edge of the header 34. In embodiments, the first-king-stud top end 36 may be affixed to the first top plate 16. In embodiments, the bottom end of the first king stud 36 may be affixed to the bottom plate 14.

The window system may further comprise a second king stud 38 comprising a top end, a bottom end, an interior surface, and an exterior surface. In embodiments, the interior surface of the second king stud 38 may be affixed to the exterior surface of the second jack stud 32 and the second side edge of the header 34. In embodiments, the second-king-stud top end 38 may be affixed to the first top plate 16. In embodiments, the bottom end of the second jack stud 32 may be affixed to the bottom plate 14.

The window system may further comprise a sill 50 comprising a first end, a second end, a top edge, and a bottom edge. In embodiments, the first end may be affixed to the interior surface of the first jack stud 30. In embodiments, the second end may be affixed to the interior surface of the second jack stud 32.

The window system may further comprise at least one bottom cripple 46 each comprising a top end and a bottom end. In embodiments, the top end of the at least one bottom cripple 46 may be affixed to the bottom edge of the sill 50. In embodiments, the bottom end of the at least one bottom cripple 46 may be affixed to the bottom plate 14.

The window system may further comprise a window frame 52 comprising an interior perimeter and an exterior perimeter. In embodiments, the exterior perimeter of the window frame 52 may be affixed to the bottom edge of the header 34, the top edge of the sill 50, the interior surface of the first jack stud 30, and the interior surface of the second jack stud 32.

The window system may further comprise a window 54 comprising an exterior perimeter. In embodiments, the exterior perimeter may be affixed to the interior perimeter of the window frame 52.

In embodiments, the prefabricated wall system 2 with a window system may further comprise at least one top cripple 46 each comprising a top end and a bottom end. The top end of the at least one top cripple 46 may be affixed to the first top plate 16. The bottom end of the at least one top cripple 46 may be affixed to the top end of the header 34.

In embodiments, the prefabricated wall system 2 with a window system may further comprise a structural connector 48 affixed adjacent a contact point of at least two of the first corner post 10, the second corner post 12, the first top plate 16, the bottom plate 14, the plurality of studs 18, the plurality of noggins 20, the first jack stud 30, the second jack stud 32, the header 34, the first king stud 36, the second king stud 38, the sill 50, the at least one bottom cripple 46, and the at least one top cripple 46. In embodiments, the structural connector 48 may be affixed via means such as, but not limited to one or more of adhesives, nails, screws, and rivets.

In embodiments, the framework of the frame layer 4 may be wood. In embodiments, the framework of the frame layer 4 may be metal. In embodiments, the framework of the frame layer 4 may be both wood and metal.

In embodiments, one of the orifices may comprise water hookups for devices such as, but not limited to, a washer. The hookups may comprise water knobs connected to water lines (hot and/or cold water lines). In embodiments, hot and/or cold water lines may be additionally affixed to appliances such as, but not limited to a water faucet, a shower, and a tub. In embodiments, the prefabricated wall system 2 may comprise a drain pipe.

In embodiments, pipes may be configured to carry gas to a specific spot on the prefabricated wall system 2 (gas pipes, essentially).

FIG. 2 displays an exterior view of a prefabricated wall system 2 in accordance with embodiments. The exterior view may show a drywall layer 6 affixed to the frame layer 4. In embodiments, the drywall layer 6 may comprise a gypsum plaster layer splayed between a first thick paper layer and a second thick paper layer. The drywall layer 6 may further comprise a plurality of orifices. In embodiments, the orifices may comprise components associated with electricity, air, or water. In embodiments, the drywall layer 6 may comprise one piece of drywall. In embodiments, the drywall layer 6 may comprise more than one piece of drywall.

The prefabricated wall system 2 may further comprise a plastic layer 8 affixed between the frame layer 4 and the drywall layer 6. The system may further comprise a plastic coating layer 26 adjacent the periphery of the frame layer 4 and the drywall layer 6. In the embodiment, the plastic layer may be comprised of any weather proofing material, including but not limited to, reflective film, insulation, and usb outlets.

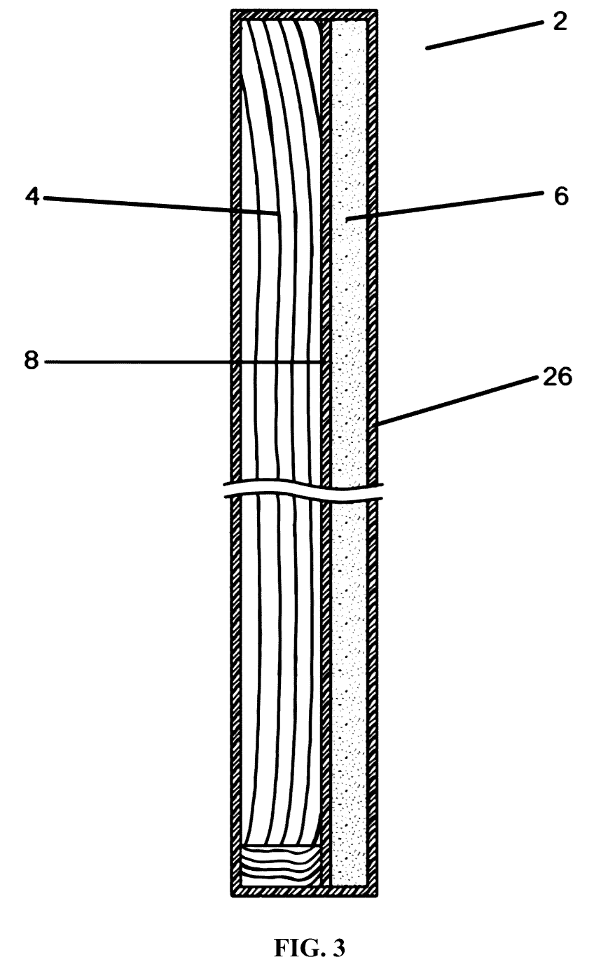

FIG. 3 depicts a side layer view of a prefabricated wall system 2 in accordance with embodiments. In embodiments, a plastic layer 8 may be affixed between the frame layer 4 and the drywall layer 6. A plastic coating layer 26 may be adjacent the periphery of the frame layer 4 and the drywall layer 6. A plastic coating layer may be adjacent the periphery of the frame layer 4 that is non-adjacent to the drywall layer 6. In the embodiment, the plastic coating layer 26 may be comprised of any weather proofing material, including but not limited to, reflective film, insulation, and usb outlets.

In embodiments, the prefabricated wall system 2 may further comprise at least one bracing 60 comprising a top end and a bottom end. The top end of the at least one bracing 60 may be affixed to the first top plate 16 and adjacent a first surface of a first stud of the plurality of studs 18. The bottom end of the at least one bracing 60 may be affixed to the bottom plate 14 and adjacent a first surface of a second stud of the plurality of studs 18. In embodiments, the at least one bracing 60 may be a cut-in bracing 60.

In embodiments, at least one cut-in bracing kicker 66 may be adjacent a second surface of the first stud of the plurality of studs 18 and adjacent a first surface of a third stud of the plurality of studs 18. The at least one cut-in bracing kicker 66 may provide support to the at least one cut-in bracing 60.

In embodiments, the prefabricated wall system 2 may comprise a plurality of pipes splayed within the frame layer 4 and the drywall layer 6. The two layers may be adapted to properly fit the pipes. Adaptations may include attachment means (such as those described herein) and/or the altering of wall components (such as making a hole). In embodiments, at least one of the plurality of pipes may be plumbing pipes 70.

In embodiments, the prefabricated wall system 2 may comprise a plurality of cables 72 splayed within the frame layer 4 and the drywall layer 6. The two layers may be adapted to properly fit the cables 72. Adaptations may include attachment means (such as those described herein) and/or the altering of wall components (such as making a hole). In embodiments, the cables 72 may be electric cables 72.

In embodiments, the prefabricated wall system 2 may comprise insulation splayed within the frame layer 4. In embodiments, the insulation may be reflective insulation.

In embodiments, the prefabricated wall system 2 may comprise at least one air vent 74 affixed within at least one of the plurality of orifices. In embodiments, the at least one air vent 74 may be directly affixed to the perimeter of the orifices via an adhesive or may be affixed via screws, nails, etc. in the vicinity of the orifices. In embodiments, the air vent 74 may comprise a duct (FIG. 2).

In embodiments, the prefabricated wall system 2 may further comprise at least one electric box 76 affixed within one of the plurality of orifices. In embodiments, the at least one electric box 76 may be directly affixed to the perimeter of the orifice via an adhesive or may be affixed via screws, nails, etc. in the vicinity of the orifice.

In embodiments, the prefabricated wall system 2 may further comprise at least one electric outlet 78 affixed within at least one of the plurality of orifices. In embodiments, the at least one electric outlet 78 may be directly affixed to the perimeter of the orifices via an adhesive or may be affixed via screws, nails, etc. in the vicinity of the orifices.

In embodiments, the prefabricated wall system 2 may further comprise at least one wall switch 80 affixed within at least one of the plurality of orifices. In embodiments, the at least one wall switch 80 may be directly affixed to the perimeter of the orifices via an adhesive or may be affixed via screws, nails, etc. in the vicinity of the orifices.

In embodiments, the prefabricated wall system 2 may further comprise a plurality of noggins 20. In embodiments, each of the plurality of noggins 20 may comprise a first end and a second end. Each of the first ends of the plurality of noggins 20 may be affixed to a first of the plurality of studs 18. Each of the second ends of the plurality of noggins 20 may be affixed to a second of the plurality of studs 18. The noggins 20 may provide additional support to the studs 18.

In embodiments, the prefabricated wall system 2 may comprise a second top plate 22 affixed to the first top plate 16. The second top plate 22 may provide additional support to the first top plate 16 and may also provide an additional area where building elements may be affixed.

In embodiments, a primer layer may be splayed on one of the first thick paper layer and the second thick paper layer of the frame layer 4.

In embodiments, the prefabricated wall system 2 may comprise at least one A/C vent and pipes associated with the A/C vent.

In embodiments, the disclosure may provide a building that may comprise at least one prefabricated wall system 2. The building may further comprise a roof.

In embodiments, the components of the prefabricated wall system 2 in FIGS. 1, 2, and 3 may be drawn to scale. In embodiments, the components of the prefabricated wall system 2 in FIGS. 1, 2, and 3 may not be drawn to scale and may vary in size and shape.

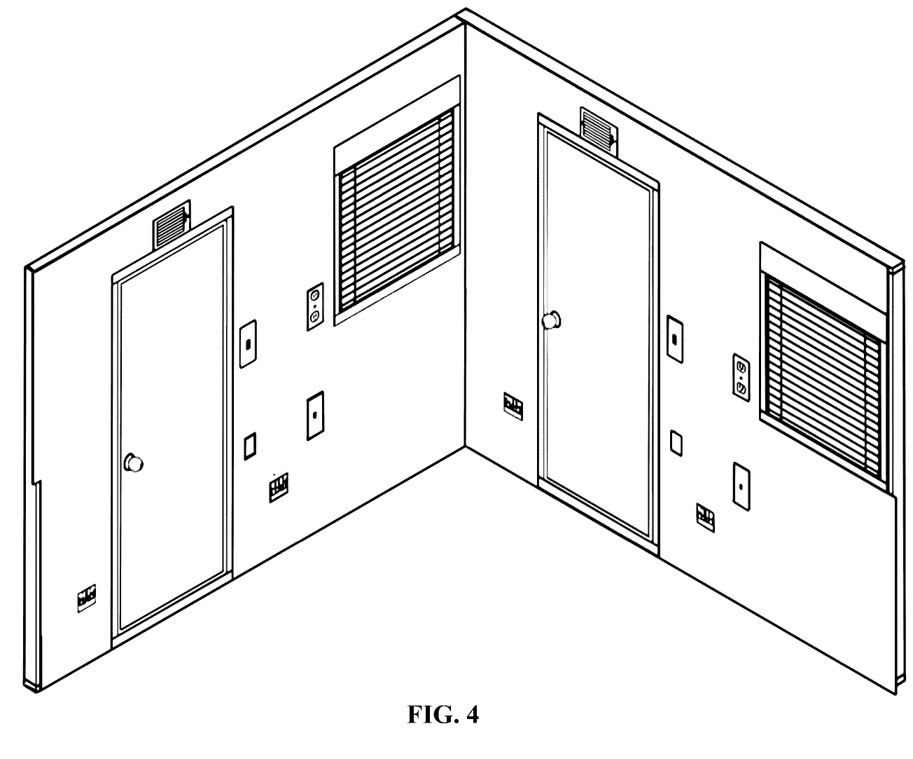

In embodiments, portions of drywall may horizontally extend farther than the frame layer 4 of the prefabricated wall system 2. In embodiments, portions of drywall may horizontally extend two inches farther than the frame layer 4. In embodiments, other portions of drywall may not extend farther than the frame layer 4 of a pre-made wall so that a portion of the first and/or second corner post 12s may be exposed when facing the drywall layer 6. In embodiments, portions of drywall may horizontally extend from walls at different portions of the walls so that the extended drywall may act as male and female portions when the walls are put together (see FIG. 4).

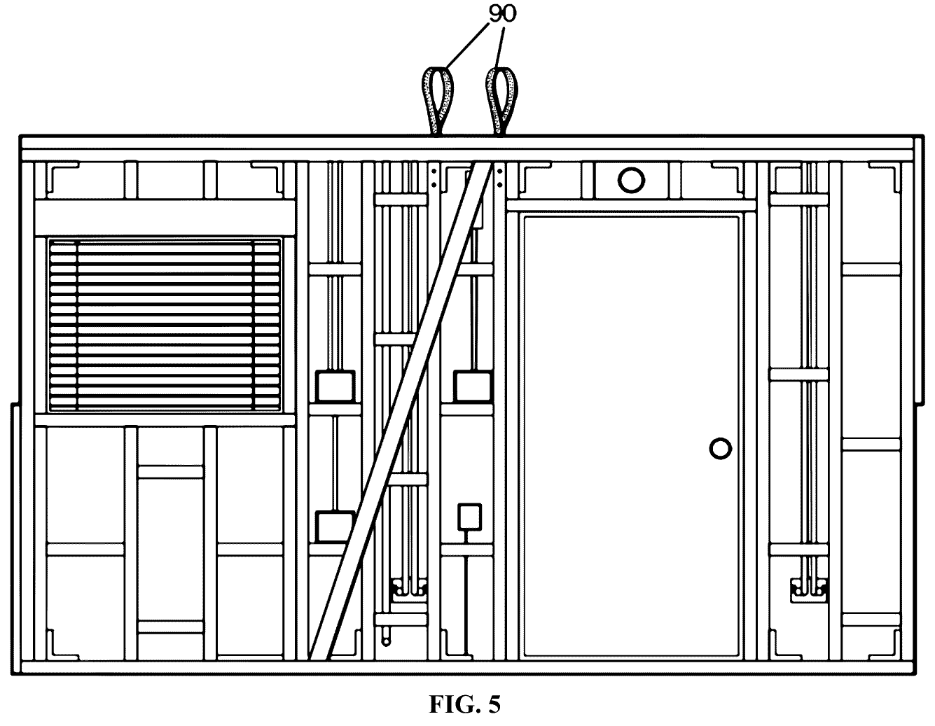

FIG. 5 depicts an interior view of a prefabricated wall system 2 including loop straps 90 in accordance with embodiments. The loop straps 90 may be adjacent the plastic layer 8 and between the frame layer 4 and the drywall layer 6. Portions of the loop straps 90 may be secured to the frame layer 4. In embodiments, the loop straps 90 may be secured to the frame layer 4 via nails. In embodiments, the loop straps 90 may be secured to the frame layer 4 via means such as, but not limited to screws, glue, nails, and staples. In embodiments, the loop straps 90 may be encompassed within the plastic layer 8. In embodiments, the loop straps 90 may be stored within the plastic layer 8 after positioning the wall. In embodiments, the straps may be removed before adding a façade and/or a drywall layer 6 to a prefabricated wall system 2. In embodiments, the straps may be left on the prefabricated wall system 2 while adding a façade and/or a drywall layer 6 to a wall.

In embodiments, portions of the drywall that extend horizontally farther than the frame layer 4 of the prefabricated wall system 2 may extend vertically four feet.

In embodiments, the drywall layer 6 may comprise four by eight (feet) sheets of drywall. In embodiments, the drywall layer 6 may comprise sheets of drywall comprising dimensions other than four by eight (feet).

In embodiments, the frame layer 4 may extend one to two inches lower than the drywall layer 6.

In embodiments, the prefabricated wall system 2 may include beads such as, but not limited to corner beads, commercial beads, decorative beads, plastic beads, metal beads and combinations thereof.

In embodiments, the prefabricated wall system 2 may comprise one or more nooks.

In embodiments, a prefabricated wall system 2 may affix to the top of another prefabricated wall system 2.

In embodiments, the drywall layer 6 may comprise any type of drywall and/or cement board.

In embodiments, a prefabricated wall system 2 may be placed on top of a beam on top of another prefabricated wall system 2. In embodiments, a prefabricated wall system 2 may be placed on a story separator on top of another prefabricated wall system 2.

For the purposes of this disclosure, when describing a door system, the description of surfaces may be in relation to the setup of the door system itself.

For the purposes of this disclosure, when describing a window system, the description of surfaces may be in relation to the setup of the window system itself.

In embodiments, components may be affixed to one another via means such as, but not limited to one or more of adhesives, nails, screws, and rivets.

While this disclosure has been particularly shown and described with reference to preferred embodiments thereof and to the accompanying drawings, it will be understood by those skilled in the art that various changes in form and details may be made therein without departing from the spirit of this disclosure. Therefore, the scope of the disclosure is defined not by the detailed description but by the appended claims.

What is claimed is:

1. A prefabricated wall system comprising:
a frame layer comprising:
a first corner post comprising a top end and a bottom end;
a second corner post comprising a top end and a bottom end;
a bottom plate affixed to the bottom end of the first corner post and the bottom end of the second corner post;
a first top plate affixed to the top end of the first corner post and the top end of the second corner post;
a plurality of studs;
and a plurality of noggins;
a drywall layer affixed to the frame layer,
the drywall layer comprising:
a gypsum plaster layer;
a first thick paper layer;
a second thick paper layer;
and
a plurality of orifices;
a plastic layer affixed between the frame layer and the drywall layer;
and
a plastic coating layer adjacent the periphery of the frame layer and the drywall layer.

2. The system of claim 1, further comprising a door system, the door system comprising:
a first jack stud comprising a top end, a bottom end, an interior surface, and an exterior surface, the bottom end of the first jack stud affixed to the bottom plate;
a second jack stud comprising a top end, a bottom end, an interior surface, and an exterior surface, the bottom end of the first jack stud affixed to the bottom plate;
a header comprising a top edge, a bottom edge, a first side edge, and a second side edge, a first portion of the bottom edge of the header affixed to the top end of the first jack stud, a second portion of the bottom edge of the header affixed to the top end of the second jack stud;
a first king stud comprising a top end, a bottom end, an interior surface, and an exterior surface, the interior surface of the first king stud affixed to the exterior surface of the first jack stud and the first side edge of the header, the top end of the first king stud affixed to the first top plate, the bottom end of the first king stud affixed to the bottom plate;
a second king stud comprising a top end, a bottom end, an interior surface, and an exterior surface, the interior surface of the second king stud affixed to the exterior surface of the second jack stud and the second side edge of the header, the top end of the second king stud affixed to the first top plate, the bottom end of the second jack stud affixed to the bottom plate;
a door frame comprising an interior perimeter and an exterior perimeter, the exterior perimeter of the door frame affixed to the bottom edge of the header, the interior surface of the first jack stud, and the interior surface of the second jack stud; and
a door comprising an exterior perimeter, a portion of the exterior perimeter affixed to the interior perimeter of the door frame.

3. The system of claim 2, further comprising at least one cripple each comprising a top end and a bottom end, the top end of the at least one cripple affixed to the first top plate, the bottom end of the at least one cripple affixed to the top end of the header.

4. The system of claim 3, further comprising at least one structural connector affixed adjacent a contact point of at least two of the first corner post, the second corner post, the first top plate, the bottom plate, the plurality of studs, the plurality of noggins, the first jack stud, the second jack stud, the header, the first king stud, the second king stud, and the at least one cripple.

5. The system of claim 1, further comprising a window system, the window system comprising:
a first jack stud comprising a top end, a bottom end, an interior surface, and an exterior surface, the bottom end of the first jack stud affixed to the bottom plate;
a second jack stud comprising a top end, a bottom end, an interior surface, and an exterior surface, the bottom end of the first jack stud affixed to the bottom plate;
a header comprising a top edge, a bottom edge, a first side edge, and a second side edge, a first portion of the bottom edge of the header affixed to the top end of the first jack stud, a second portion of the bottom edge of the header affixed to the top end of the second jack stud;
a first king stud comprising a top end, a bottom end, an interior surface, and an exterior surface, the interior surface of the first king stud affixed to the exterior surface of the first jack stud and the first side edge of the header, the top end of the first king stud affixed to the first top plate, the bottom end of the first king stud affixed to the bottom plate;
a second king stud comprising a top end, a bottom end, an interior surface, and an exterior surface, the interior surface of the second king stud affixed to the exterior surface of the second jack stud and the second side edge of the header, the top end of the second king stud affixed to the first top plate, the bottom end of the second jack stud affixed to the bottom plate;
a sill comprising a first end, a second end, a top edge, and a bottom edge, the first end affixed to the interior surface of the first jack stud, the second end affixed to the interior surface of the second jack stud;
at least one bottom cripple each comprising a top end and a bottom end, the top end of the at least one bottom cripple affixed to the bottom edge of the sill, the bottom end of the at least one bottom cripple affixed to the bottom plate;
a window frame comprising an interior perimeter and an exterior perimeter, the exterior perimeter of the window frame affixed to the bottom edge of the header, the top edge of the sill, the interior surface of the first jack stud, and the interior surface of the second jack stud; and
a window comprising an exterior perimeter, the exterior perimeter affixed to the interior perimeter of the window frame.

6. The system of claim 5, further comprising at least one top cripple each comprising a top end and a bottom end, the top end of the at least one top cripple affixed to the first top plate, the bottom end of the at least one top cripple affixed to the top end of the header.

7. The system of claim 6, further comprising at least one structural connector affixed adjacent a contact point of at least two of the first corner post, the second corner post, the first top plate, the bottom plate, the plurality of studs, the plurality of noggins, the first jack stud, the second jack stud, the header, the first king stud, the second king stud, the sill, the at least one bottom cripple, and the at least one top cripple.

8. The system of claim 1, further comprising at least one bracing each comprising a top end and a bottom end, the top end of the at least one bracing affixed to the first top plate and adjacent a first surface of a first stud of the plurality of studs, the bottom end of the at least one bracing affixed to the bottom plate and adjacent a first surface of a second stud of the plurality of studs.

9. The system of claim 8, at least one of the at least one bracing being a cut-in bracing.

10. The system of claim 9, further comprising at least one cut-in bracing kicker adjacent a second surface of the first stud of the plurality of studs and adjacent a first surface of a third stud of the plurality of studs.

11. The system of claim 1, further comprising a plurality of pipes splayed within the frame layer and the drywall layer.

12. The system of claim 1, at least one of the plurality of pipes being a plumbing pipe.

13. The system of claim 1, further comprising a plurality of cables splayed within the frame layer and the drywall layer.

14. The system of claim 1, further comprising insulation splayed within the frame layer.

15. The system of claim 1, further comprising an air vent affixed within one of the plurality of orifices.

16. The system of claim 1, further comprising an electric box affixed within one of the plurality of orifices.

17. The system of claim 1, further comprising an electric outlet affixed within one of the plurality of orifices.

18. The system of claim 1, further comprising a wall switch affixed within one of the plurality of orifices.

19. The system of claim 1, each of the plurality of noggins comprising a first end and a second end, each of the first ends of the plurality of noggins affixed to a first of the plurality of studs, each of the second ends of the plurality of noggins affixed to a second of the plurality of studs.

20. The system of claim 1, further comprising a second top plate affixed to the first top plate.

21. The system of claim 1, further comprising a primer layer splayed on one of the first thick paper layer and the second thick paper layer.
